(19) United States
(12) Patent Application Publication
(10) Pub. No.: US 2024/0048039 A1
(43) Pub. Date: Feb. 8, 2024

(54) POWER MANAGEMENT CIRCUIT AND CALIBRATION METHOD OF POWER MANAGEMENT CIRCUIT

(71) Applicant: ROHM Co., LTD., Kyoto (JP)

(72) Inventors: Kenji Yamada, Kyoto (JP); Nobuyuki Yokoyama, Kyoto (JP)

(21) Appl. No.: 18/363,804

(22) Filed: Aug. 2, 2023

(30) Foreign Application Priority Data
Aug. 8, 2022 (JP) 2022-126662

(51) Int. Cl. H02M 1/00; H02M 3/04

(52) U.S. Cl. CPC H02M 1/0012; H02M 3/04

(57) ABSTRACT

Provided is a power management circuit including power supply circuits of a plurality of channels, a register that stores a plurality of digital values corresponding to the power supply circuits of the plurality of channels, a plurality of voltage monitor circuits corresponding to the power supply circuits of the plurality of channels, each of the plurality of voltage monitor circuits comparing an output voltage of a corresponding one of the power supply circuits with a threshold voltage corresponding to a corresponding one of the plurality of digital values, a control logic that sweeps the plurality of digital values stored in the register, while maintaining the digital values to be the same value in a calibration mode, and a non-volatile memory that stores, for each of the plurality of channels, a digital value when a determination result of the voltage monitor circuit changes.

### CROSS REFERENCE TO RELATED APPLICATIONS

This application claims priority benefit of Japanese Patent Application No. JP 2022-126662 filed in the Japan Patent Office on Aug. 8, 2022. Each of the above-referenced applications is hereby incorporated herein by reference in its entirety.

### BACKGROUND

The present disclosure relates to a power management circuit that manages and controls power supplies of a plurality of channels.

An electronic device includes various circuits (hereinafter, collectively referred to as load circuits), such as processors including a microcontroller and a central processing unit (CPU), a memory, an interface circuit including a universal serial bus (USB), a liquid crystal display, and an audio circuit. A power management integrated circuit (PMIC) is used to supply appropriate power supply voltages to the load circuits. The PMIC includes power supply circuits of a plurality of channels and a sequencer that turns on and off the power supply circuits of the plurality of channels according to a predetermined sequence.

An example of the related art is disclosed in Japanese Patent No. 6917819.

### BRIEF DESCRIPTION OF THE DRAWINGS

FIG. 1 is a block diagram of an electronic device including a PMIC according to a first embodiment;

FIG. 2 is a block diagram related to a voltage monitor circuit;

FIG. 3 is an explanatory diagram of trimming of over voltage detection in the PMIC; and

FIG. 4 is a block diagram of a PMIC according to a second embodiment.

### DETAILED DESCRIPTION

### Overview of Embodiments

An overview of some exemplary embodiments of the present disclosure will be described. The overview simply describes some concepts of one or a plurality of embodiments for basic understanding of the embodiments as a preface to detailed explanation described later, and the overview does not limit the extent of the technology or the disclosure. The overview is not a comprehensive overview of all conceivable embodiments, and the overview is not intended to specify important elements of all the embodiments or to define the scope of some of or all the embodiments. For convenience, “one embodiment” may be used to represent one embodiment (example or modification) or a plurality of embodiments (examples or modifications) disclosed in the present specification.

An embodiment provides a power management circuit including power supply circuits of a plurality of channels, a register that stores a plurality of digital values corresponding to the power supply circuits of the plurality of channels, a plurality of voltage monitor circuits corresponding to the power supply circuits of the plurality of channels, each of the plurality of voltage monitor circuits comparing an output voltage of a corresponding one of the power supply circuits with a threshold voltage corresponding to a corresponding one of the plurality of digital values, a control logic that sweeps the plurality of digital values stored in the register, while maintaining the digital values to be the same value in a calibration mode, and a non-volatile memory that stores, for each of the plurality of channels, a digital value when a determination result of the voltage monitor circuit changes.

According to this configuration, the control logic simultaneously sweeps the plurality of digital values defining the thresholds of the plurality of voltage monitor circuits, and setting of the thresholds of the voltage monitor circuits of the plurality of channels can be completed in a short period of time.

In an embodiment, the power management circuit may further include a general-purpose input/output pin. The control logic may increment or decrement the plurality of digital values in synchronization with a clock signal input from outside to the general-purpose input/output pin.

In an embodiment, the power management circuit may further include an internal oscillator. The control logic may increment or decrement the plurality of digital values in synchronization with a clock generated by the internal oscillator.

In an embodiment, at least one of the plurality of voltage monitor circuits may be an over voltage detection circuit.

In an embodiment, at least one of the plurality of voltage monitor circuits may be an under voltage detection circuit.

In an embodiment, the power management circuit may be integrated into one semiconductor substrate. The “integration” includes a case in which all of the constituent elements of the circuit are formed on the semiconductor substrate and a case in which main constituent elements of the circuit are integrated. Some of the resistors and capacitors, for example, for adjusting the circuit constants may be provided outside the semiconductor substrate. By integrating the circuit on one chip, the circuit area can be reduced, and the characteristics of the circuit elements can be kept uniform.

An embodiment provides a calibration method of a power management circuit, the calibration method including a step of applying a voltage corresponding to the threshold voltage from outside to an output terminal of each of the power supply circuits of the plurality of channels, a step of sweeping the plurality of digital values all together while maintaining the digital values to be the same value, and a step of saving, for each of the plurality of channels, a set value of the register when a determination result of the voltage monitor circuit changes, in a non-volatile memory.

### EMBODIMENTS

Preferred embodiments will now be described with reference to the drawings. The same signs are provided to the same or equivalent constituent elements, members, and processes illustrated in the drawings, and duplicate description will appropriately be omitted. The embodiments are exemplary, and not intended to limit the disclosure or the technology. All features and combinations of the features described in the embodiments may not be essential for the disclosure and the technology.

The dimension (such as a thickness, a length, and a width) of each member described in the drawings is appropriately scaled in some cases to facilitate the understanding. The dimensions of a plurality of members may not always represent the magnitude relation between the members, and a member A may be thinner than another member B even if the member A is thicker than the member B in the drawings.

In the present specification, a “state in which a member A is connected to a member B” includes a case in which the member A and the member B are physically and directly connected to each other as well as a case in which the member A and the member B are indirectly connected to each other through another member that does not substantially affect their electrical connection state and that does not impair functions and effects obtained by coupling of the members A and B.

Similarly, a “state in which a member C is connected (provided) between a member A and a member B” includes a case in which the member A and the member C or the member B and the member C are directly connected to each other as well as a case in which they are indirectly connected to each other through another member that does not substantially affect their electrical connection state and that does not impair functions and effects obtained by coupling of the members A and C or the members B and C.

In the present specification, the signs provided to electrical signals, such as voltage signals and current signals, as well as circuit elements, such as resistors, capacitors, and inductors, represent their voltage values, current values, or circuit constants (resistance values, capacitance values, or inductances) as necessary.

### First Embodiment

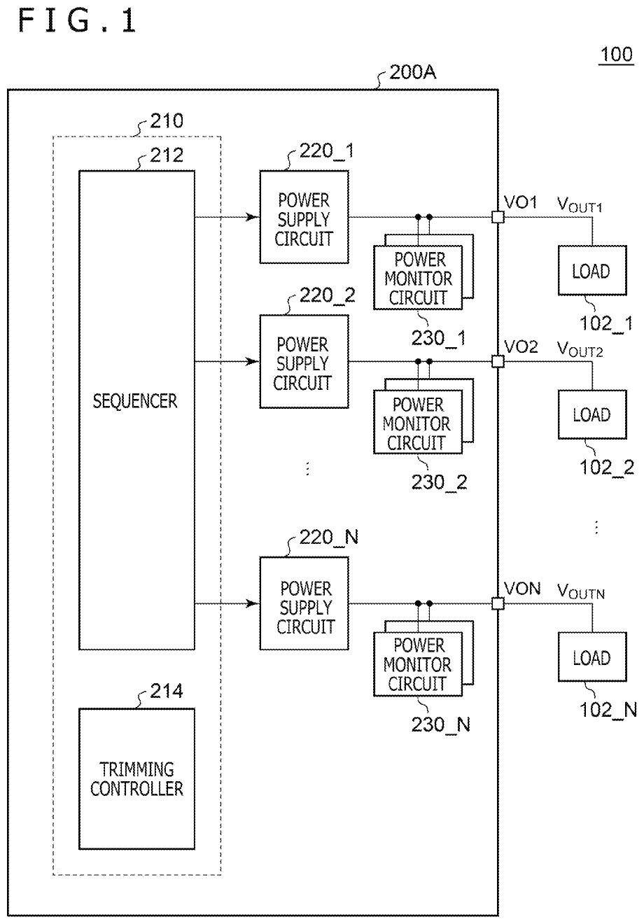

FIG. 1 is a block diagram of an electronic device 100 including a PMIC 200A according to a first embodiment. The electronic device 100 includes the PMIC 200A and a plurality of load circuits 102. Examples of the load circuits 102 include, but not limited to, CPUs, memories, and various application specific integrated circuits (ASICs).

The PMIC 200A supplies power supply voltages V_{OUT1} to V_{OUTN} to a plurality of load circuits 102_1 to 102_N.

The PMIC 200A includes a control logic 210, N (N≥2) power supply circuits 220, and a plurality of voltage monitor circuits 230_1 to 230_N, and the PMIC 200A is a functional IC integrated into one semiconductor substrate. A configuration corresponding to one load will be referred to as a channel CH. The PMIC 200A includes the power supply circuit 220 and the voltage monitor circuit 230 for each channel.

Power supply circuits 220_1 to 220_N of a plurality of channels may include switching power supplies, such as boost converters, buck converters, buck-boost converters, and charge pump circuits, or may include linear regulators. The target level of an output voltage V_{OUTi} of a power supply circuit 220_i of each channel CHi (i=1, 2, . . . N) is defined for each power supply circuit 220.

A voltage monitor circuit 230_i corresponds to the power supply circuit 220_i of each channel CHi. The voltage monitor circuit 230_i of each channel CHi monitors the output voltage V_{OUTi} of the corresponding power supply circuit 220_i and determines whether the output voltage V_{OUTi} is included in a normal voltage range or deviates from the normal voltage range. The determination result is supplied to the control logic 210. As described later, the voltage monitor circuit 230 may include, for example, an over voltage detection (OVD) circuit and an under voltage detection (UVD) circuit.

The control logic 210 includes a sequencer 212 and a trimming controller 214. The sequencer 212 follows a predetermined sequence to control ON and OFF of the power supply circuits 220_1 to 220_N of the plurality of channels according to state transition of the electronic device 100. Examples of the state of the electronic device 100 include, but not limited to, a completely OFF state, a standby state, and a normal operation state. The state of the electronic device 100 varies according to the type and the usage of the electronic device 100.

As described above, the target level of the output voltage V_{OUTi} of each channel CHi varies according to the type and the usage of the electronic device 100. Therefore, the normal voltage range of the voltage monitor circuit 230_i needs to be set according to the target level of the output voltage V_{OUTi} of each channel CHi. The trimming controller 214 sets an appropriate voltage range for each of the voltage monitor circuits 230_1 to 230_N in a trimming process of a manufacturing process of the PMIC 200A or a manufacturing process of the electronic device 100.

This completes the description of the overall configuration of the PMIC 200A. Next, trimming of the voltage monitor circuit 230 will be described in detail.

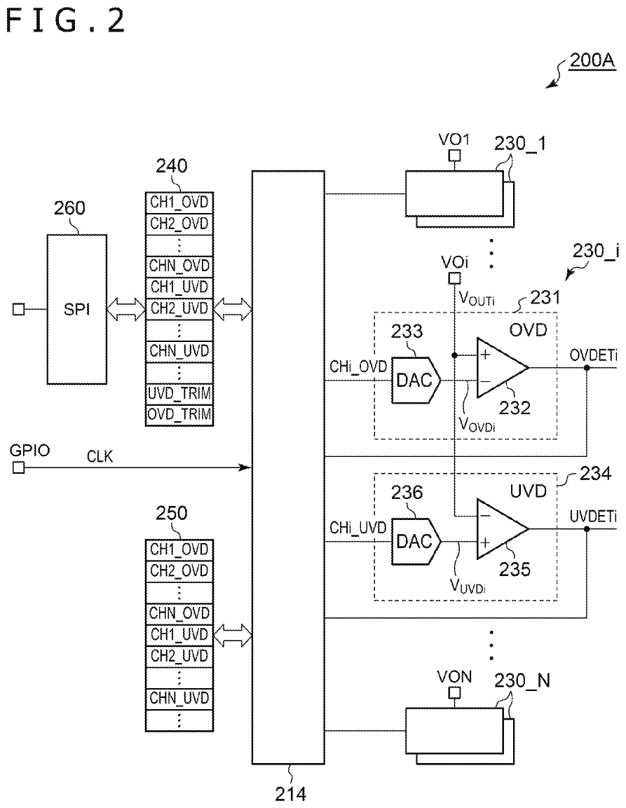

FIG. 2 is a block diagram related to the voltage monitor circuit 230. The PMIC 200A includes a register 240, a non-volatile memory 250, and a serial interface circuit 260 in addition to the voltage monitor circuits 230_1 to 230_N and the trimming controller 214.

The voltage monitor circuit 230_i includes an OVD circuit 231 and a UVD circuit 234. The OVD circuit 231 includes a voltage comparator 232 and a digital-to-analog (D/A) converter 233.

The D/A converter 233 of the OVD circuit 231 receives, from the trimming controller 214, a digital signal CHi_OVD defining a threshold for over voltage detection and converts the digital signal CHi_OVD into an analog threshold voltage V_{OVDi}.

The voltage comparator 232 compares the corresponding output voltage V_{OUTi} with the threshold voltage V_{OVDi} and asserts an over voltage detection signal OVDETi (for example, shifts the signal to a high level) if V_{OUTi}>V_{OVDi}.

The configuration of the UVD circuit 234 can be similar to the configuration of the OVD circuit 231, and the UVD circuit 234 includes a voltage comparator 235 and a D/A converter 236.

The D/A converter 236 of the UVD circuit 234 receives, from the trimming controller 214, a digital signal CHi_UVD defining a threshold for under voltage detection and converts the digital signal CHi_UVD into an analog threshold voltage V_{UVDi}.

The voltage comparator 235 compares the corresponding output voltage V_{OUTi} with the threshold voltage V_{UVDi} and asserts an under voltage detection signal UVDETi (for example, shifts the signal to a high level) if V_{OUTi}<V_{UVDi}.

The non-volatile memory 250 holds a plurality of digital values CH1_OVD to CHN_OVD defining the over voltage thresholds used in the normal operation state. The trimming controller 214 reads the digital values from the non-volatile memory 250 at the start of the PMIC 200A and loads the digital values on corresponding addresses of the register 240. The digital values CH1_OVD to CHN_OVD stored in the register 240 are supplied to the voltage monitor circuits 230_1 to 230_N. This similarly applies to digital values CH1_UVD to CHN_UVD related to the under voltage detection.

The trimming controller 214 is set to a trimming mode in the trimming process of the manufacturing process of the PMIC 200A or the manufacturing process of the electronic device 100. For example, an external host controller writes “1” to a predetermined address of the register 240 through the serial interface circuit 260, and the PMIC 200A shifts to the trimming mode.

### (Trimming of Over Voltage Detection)

A flag OVD_TRIM for starting trimming of the over voltage detection is stored in a predetermined address of the register 240. The trimming related to the over voltage detection is started once an external tester sets the flag OVD_TRIM to a value “1” through the serial interface circuit 260.

Prior to the trimming, the external tester applies voltages corresponding to thresholds for the over voltage detection to output terminals VO1 to VON of the power supply circuits of the plurality of channels.

The trimming controller 214 sets the plurality of digital values CH1_OVD to CHN_OVD of the register 240 to the same trimming value TRIM as an initial value. The initial value can be a minimum value (or a maximum value) of the digital value.

The PMIC 200A receives a clock signal CLK from the outside. The clock signal CLK is input to, for example, a general-purpose input/output pin (GPIO) of the PMIC 200A. In synchronization with the clock signal CLK, the PMIC 200A sweeps the plurality of digital values CH1_OVD to CHN_OVD (trimming value TRIM) of the register 240 from the initial value while maintaining the digital values CH1_OVD to CHN_OVD to be the same value.

The trimming controller 214 monitors over voltage detection signals OVD_DET1 to OVD_DETN of the plurality of channels while changing the digital values CH1_OVD to CHN_OVD (trimming value TRIM) of the register 240. When an over voltage detection signal OVD_DETj of a channel CHj changes, the trimming controller 214 stores a value CHj_OVD of the register 240 at this point in the non-volatile memory 250.

The set values CH1_OVD to CHN_OVD of all channels are determined once the sweeping of the digital values CH1_OVD to CHN_OVD of the register 240 is completed.

### (Trimming of Under Voltage Detection)

Prior to the trimming, an external tester applies voltages corresponding to thresholds for the under voltage detection to the output terminals VO1 to VON of the power supply circuits of the plurality of channels.

A flag UVD TRIM for starting trimming of the under voltage detection is stored in a predetermined address of the register 240. The trimming related to the under voltage detection is started once the external tester sets the flag UVD TRIM to a value “1” through the serial interface circuit 260.

The trimming controller 214 sets the plurality of digital values CH1_UVD to CHN_UVD of the register 240 to the same trimming value TRIM as an initial value. The initial value can be a minimum value (or a maximum value) of the digital value.

In synchronization with the clock signal CLK, the PMIC 200A sweeps the plurality of digital values CH1_UVD to CHN_UVD of the register 240 from the initial value while maintaining the digital values CH1_UVD to CHN_UVD to be the same trimming value TRIM.

The trimming controller 214 monitors under voltage detection signals UVD_DET1 to UVD_DETN of the plurality of channels while changing the digital values CH1_UVD to CHN_UVD (that is, the trimming value TRIM) of the register 240. When an under voltage detection signal UVD_DETj of a channel CHj changes, the trimming controller 214 stores a value CHj UVD of the register 240 at this point in the non-volatile memory 250.

The set values CH1_UVD to CHN_UVD of all channels are determined once the sweeping of the digital values CH1_UVD to CHN_UVD of the register 240 is completed.

This completes the description of the configuration of the PMIC 200A. Next, an operation of the PMIC 200A will be described.

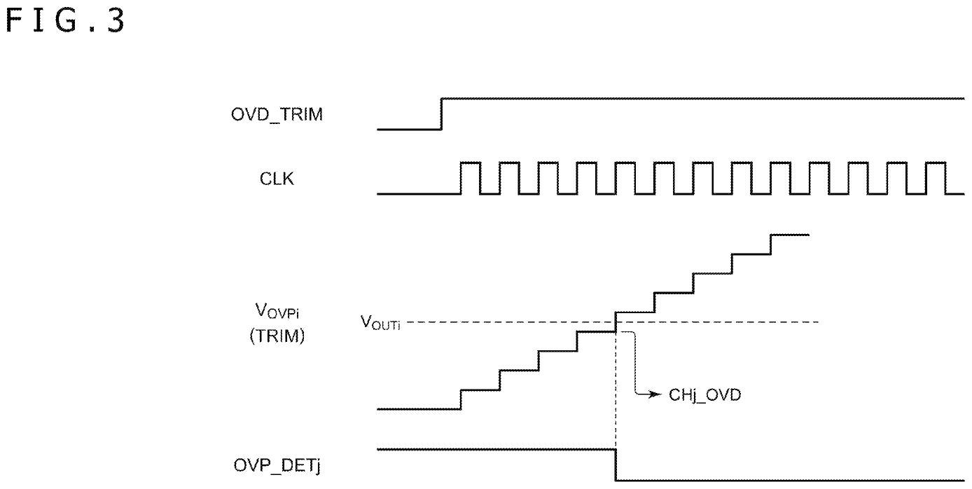

FIG. 3 is an explanatory diagram of the trimming of the over voltage detection in the PMIC 200A. Once the flag OVD_TRIM is asserted at time to, the trimming value TRIM of the digital values CH1_OVD to CHN_OVD is initialized.

The trimming value TRIM is incremented in synchronization with the clock signal CLK. A threshold V_{OVDj} in the OVD circuit 231 increases one step at a time with the increment in the trimming value TRIM. Once the threshold V_{OVDj} crosses an output voltage V_{OUTj} in the channel CHj at time t₁, the trimming value TRIM at time t₁ is determined as the set value CHj_OVD of the over voltage threshold voltage, and the set value CHj_OVD is then written to the non-volatile memory 250.

The trimming of the under voltage detection is similarly performed.

This completes the description of the operation of the PMIC 200A. According to the PMIC 200A, the trimming of the voltage monitor circuits 230_1 to 230_N of the plurality of channels can be performed all together, and the trimming can be completed in a short period of time. This advantage becomes clearer by comparison with a comparative technique.

### (Comparative Technique)

The trimming is performed for one channel at a time in the comparative technique. An example of the trimming of the over voltage detection will be described here. The external tester of the PMIC 200A uses serial communication with the serial interface circuit 260 to initialize the value CHj_OVD of the channel CHj (j=1, 2, . . . N) of the register 240. The serial communication is used to sequentially update the value CHj_OVD of the register 240 and detect the point where the over voltage detection signal OVDETj changes. Once the set value is found for a channel, the trimming shifts to the trimming of the next channel CH.

If there are M possible values of the set value CHj_OVD including 0 to M−1, the serial communication needs to be performed M times in the comparative technique. The serial communication needs to be performed M×N times for the trimming of all the channels.

On the other hand, the serial communication is necessary only for mode control in the first embodiment, and the trimming controller 214 automatically changes the trimming value TRIM. Therefore, the number of times of communication is significantly reduced. Further, all the channels can be inspected all together in the first embodiment, and the time required for the trimming can be significantly shorter than that in the comparative technique.

### Second Embodiment

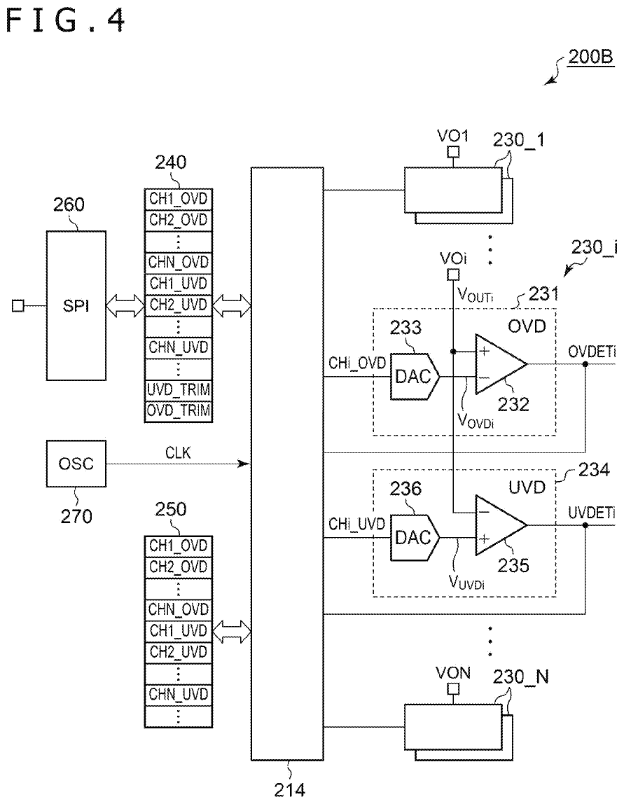

FIG. 4 is a block diagram of a PMIC 200B according to a second embodiment. The PMIC 200B includes an internal oscillator 270. The trimming controller 214 increments (or decrements) the trimming value TRIM in synchronization with the clock signal CLK generated by the internal oscillator 270.

The configuration other than the above of the second embodiment is similar to the configuration of the first embodiment. According to the configuration of the second embodiment, an effect similar to the effect of the first embodiment can also be obtained.

### (Supplement)

The following technique is disclosed in the present disclosure.

### (Item 1)

A power management circuit including:
power supply circuits of a plurality of channels;
a register that stores a plurality of digital values corresponding to the power supply circuits of the plurality of channels;
a plurality of voltage monitor circuits corresponding to the power supply circuits of the plurality of channels, each of the plurality of voltage monitor circuits comparing an output voltage of a corresponding one of the power supply circuits with a threshold voltage corresponding to a corresponding one of the plurality of digital values;
a control logic that sweeps the plurality of digital values stored in the register, while maintaining the digital values to be the same value in a calibration mode; and
a non-volatile memory that stores, for each of the plurality of channels, a digital value when a determination result of the voltage monitor circuit changes.

### (Item 2)

The power management circuit according to Item 1, further including:
a general-purpose input/output pin, in which
the control logic increments or decrements the plurality of digital values in synchronization with a clock signal input from outside to the general-purpose input/output pin.

### (Item 3)

The power management circuit according to Item 1, further including:
an internal oscillator, in which
the control logic increments or decrements the plurality of digital values in synchronization with a clock generated by the internal oscillator.

### (Item 4)

The power management circuit according to any one of Items 1 to 3, in which
at least one of the plurality of voltage monitor circuits is an over voltage detection circuit.

### (Item 5)

The power management circuit according to any one of Items 1 to 4, in which
at least one of the plurality of voltage monitor circuits is an under voltage detection circuit.

### (Item 6)

The power management circuit according to any one of Items 1 to 5, in which
the power management circuit is integrated into one semiconductor substrate.

### (Item 7)

A calibration method of a power management circuit,
the power management circuit including
   power supply circuits of a plurality of channels,
   a register that stores a plurality of digital values corresponding to the power supply circuits of the plurality of channels, and
   a plurality of voltage monitor circuits corresponding to the power supply circuits of the plurality of channels, each of the plurality of voltage monitor circuits comparing an output voltage of a corresponding one of the power supply circuits with a threshold voltage corresponding to a corresponding one of the plurality of digital values,
the calibration method including:
applying a voltage corresponding to the threshold voltage from outside to an output terminal of each of the power supply circuits of the plurality of channels;
sweeping the plurality of digital values all together while maintaining the digital values to be the same value; and
saving, for each of the plurality of channels, a set value of the register when a determination result of the voltage monitor circuit changes, in a non-volatile memory.

The embodiments are illustrative, and those skilled in the art will understand that there can be various modifications for the combinations of the constituent elements and the processes of the embodiments and that the modifications can be included in the present disclosure and the scope of the present technology.

According to an embodiment of the present disclosure, the thresholds of the voltage monitor circuits of a plurality of channels can be set in a short period of time.

What is claimed is:

1. A power management circuit comprising:
power supply circuits of a plurality of channels;
a register that stores a plurality of digital values corresponding to the power supply circuits of the plurality of channels;
a plurality of voltage monitor circuits corresponding to the power supply circuits of the plurality of channels, each of the plurality of voltage monitor circuits comparing an output voltage of a corresponding one of the power supply circuits with a threshold voltage corresponding to a corresponding one of the plurality of digital values;
a control logic that sweeps the plurality of digital values stored in the register, while maintaining the digital values to be a same value in a calibration mode; and
a non-volatile memory that stores, for each of the plurality of channels, a digital value when a determination result of the voltage monitor circuit changes.

2. The power management circuit according to claim 1, further comprising:
a general-purpose input/output pin, wherein
the control logic increments or decrements the plurality of digital values in synchronization with a clock signal input from outside to the general-purpose input/output pin.

3. The power management circuit according to claim 1, further comprising:
an internal oscillator, wherein
the control logic increments or decrements the plurality of digital values in synchronization with a clock generated by the internal oscillator.

4. The power management circuit according to claim 1, wherein
at least one of the plurality of voltage monitor circuits is an over voltage detection circuit.

5. The power management circuit according to claim 1, wherein
at least one of the plurality of voltage monitor circuits is an under voltage detection circuit.

6. The power management circuit according to claim 1, wherein
the power management circuit is integrated into one semiconductor substrate.

7. A calibration method of a power management circuit,
the power management circuit including
power supply circuits of a plurality of channels,
a plurality of registers corresponding to the power supply circuits of the plurality of channels, and
a plurality of voltage monitor circuits corresponding to the power supply circuits of the plurality of channels, each of the plurality of voltage monitor circuits comparing an output voltage of a corresponding one of the power supply circuits with a threshold voltage corresponding to a value of a corresponding one of the registers,
the calibration method comprising:
applying a voltage corresponding to the threshold voltage from outside to an output terminal of each of the power supply circuits of the plurality of channels;
sweeping values all together while providing the same values to the plurality of registers; and
saving, for each of the plurality of channels, a set value of the register when a determination result of the voltage monitor circuit changes, in a non-volatile memory.
